(19) United States
(12) Patent Application Publication
(10) Pub. No.: US 2019/0233983 A1
(43) Pub. Date: Aug. 1, 2019

(54) FIBER-FILLED MATERIAL AND FIBER PRODUCT OBTAINED BY USING SAME

(71) Applicant: Toray Industries, Inc., Tokyo (JP)

(72) Inventors: Isshin Katsube, Osaka-shi (JP); Masato Masuda, Mishima-shi (JP)

(21) Appl. No.: 16/330,979

(22) PCT Filed: Sep. 12, 2017
(86) PCT No.: PCT/JP2017/032898

§ 371 Date: Mar. 6, 2019

(30) Foreign Application Priority Data
Sep. 14, 2016 (JP) 2016-179244

(51) Int. Cl. D02G 3/34; B68G 1/00; A41D 31/06

(52) U.S. Cl. CPC D02G 3/34; B68G 1/00; D10B 2501/04; A41D 2500/30; A41D 31/06

(57) ABSTRACT

A fiber-filled material composed of batting and ticking made of synthetic fibers, wherein the batting made of synthetic fibers includes a bulky yarn in which (1) a fineness ratio of a sheath yarn to a core yarn (sheath/core) is 0.5-2.0, (2) entanglement points of the core yarn with the sheath yarn in a fiber axis direction are present at 1-30/mm, and (3) a radius of curvature of the sheath yarn forming loops is 2.0-30.0 mm.

### TECHNICAL FIELD

This disclosure relates to a fiber-filled material composed of batting and ticking made of synthetic fibers, and a fiber product obtained by using the same.

### BACKGROUND

Batting composed of natural materials such as feathers, or synthetic fibers is generally widely used as a filled material for heat-retaining clothing. In particular, as natural feathers, a mixture of down balls (in a granular cotton form) collected in a small amount from the chest of waterfowls and feathers (in a fluffy form) is generally used. Natural feathers are rich in supple texture, easy to follow the body shape, and exhibit excellent lightweight feeling and heat retaining property owing to the special structural form formed of their keratin fibers. For this reason, functions of products including natural feathers as batting have been recognized by even general users, and natural feathers are widely used in bedclothes or clothing items such as jackets.

However, capture of waterfowl is restricted from the viewpoint of nature conservation, and the total production of natural feathers is restricted. Furthermore, due to abnormal weather and occurrence of plague in recent years, the supply amount fluctuates greatly, and in addition to price increase, the unstable supply amount is a problem. In addition, because when natural feathers are used, peculiar odor and animal allergies are often at issue, despite many steps such as collection, screening, disinfection and degreasing of the feathers, and from the viewpoint of animal welfare, there are movements to eliminate the use of natural feathers in Europe and elsewhere. For this reason, attention is being paid to batting made of synthetic fibers that permits stable supply and so on.

Although batting obtained by using natural feathers has heat retaining ability when dried, it has long been known that “wetting” caused by not only rain or snow but also sweat, moisture and the like during action greatly reduces the heat retaining ability, and natural feathers have low quick drying property so that recovery of heat retaining ability is very poor. For this reason, batting made of synthetic fibers capable of exerting a certain degree of heat retaining ability even when wetted, and achieving quick recovery from “wetting” that reduces the heat retaining property with excellent quick drying property after wetted is required from the market.

Many kinds of batting made of synthetic fibers have been proposed. For example, Japanese Patent Laid-open Publication No. 2012-67429 discloses a filled product made of ticking filled with stiffing that is long fiber-batting formed by integrating an effect yarn with a core yarn, in which the batting is sewn to the ticking to be integrated with the ticking.

In addition, Japanese Patent Laid-open Publication No. 2012-67430 discloses a technique of injecting compressed air to thread traveling inside an interlacing nozzle from a direction perpendicular to the thread to open the thread and tangle yarns so that the excessively supplied yarns are fixed to each other by the difference in yarn length.

However, in each batting made of synthetic fibers of JP '429 and JP '430, there still remains a problem that the batting is not comparable to natural feathers in supple texture and lightweight feeling (bulkiness), and like feathers, the puff feeling is lost and the heat retaining property is quickly lowered when wetted or when moisture such as sweat during sports or the like infiltrates the batting.

For this reason, as disclosed in Japanese Patent Laid-open Publication No. 2013-136858, sheet-like batting in which short fibers are laminated has been proposed.

However, the batting in JP '858 lacks supple texture and lightweight feeling (bulkiness), and although it is said to have a heat retaining function even when wetted, high heat retaining property cannot be currently expected when wetted.

The batting of JP '858 lacks supple texture and lightweight feeling (bulkiness) because the amount of fine voids (dead air) inside the batting is small, and high heat retaining property cannot be expected because fine voids are occupied by water when wetted.

It could therefore be helpful to provide batting made of synthetic fibers having many fine voids, excellent bulkiness when dried, a supple texture and lightweight feeling, and further retains heat retaining property even when wetted, and a fiber product obtained by using the batting.

### SUMMARY

We examined the fineness ratio of sheath yarn to core yarn, the entanglement point and the radius of curvature of sheath yarn for bulky yarn constituting batting, and succeeded in creating many fine voids (dead air) inside the batting.

We thus provide a fiber-filled material composed of batting and ticking made of synthetic fibers, characterized in that the batting made of synthetic fibers comprises a bulky yarn in which (1) the fineness ratio of a sheath yarn to a core yarn (sheath/core) is 0.5-2.0, (2) entanglement points of the core yarn with the sheath yarn in the fiber axis direction are present at 1-30/mm, and (3) the radius of curvature of the sheath yarn forming loops is 2.0-30.0 mm. Also, the fiber product is characterized in that the fiber-filled material is used in at least a portion of the fiber product.

The fiber-filled material has many fine voids, excellent bulkiness when dried, a supple texture and lightweight feeling, and further retains heat retaining property even when wetted. Therefore, the fiber-filled material can be applied in a wide range of fields from clothing applications to industrial material applications.

### BRIEF DESCRIPTION OF THE DRAWINGS

FIG. 1 is a schematic side view of a bulky yarn according to an example.

FIG. 2 is a simulated view for illustrating a three-dimensionally crimped structure.

FIG. 3 is a schematic process diagram schematically showing an example of a method of producing a bulky yarn.

FIG. 4 is a simulated view for illustrating injection angles of compressed air in a method of producing a bulky yarn.

FIG. 5 is a simulated view for illustrating a discharge hole for a hollow cross section in a method of producing a bulky yarn.

### DESCRIPTION OF REFERENCE SIGNS

1: Sheath yarn
2: Core yarn
3: Three-dimensional crimp
7: Supply roller
8: Synthetic fiber
9: Suction nozzle
10: Swirling point
11: Bulky yarn
12: Take-up roller
13: Tube heater
14: Delivery roller
15: Winder
16: Injection angle of compressed air
17: Slit

### DETAILED DESCRIPTION

Hereinafter, we provide detailed description of an example of batting for a filled material and a fiber product obtained by using the same.

The fiber-filled material is made up of batting and ticking made of synthetic fibers. A bulky yarn for use in the batting made of synthetic fibers is made of synthetic fibers and has a bulky structure. This bulky structure is composed of a sheath yarn forming loops and a core yarn that entangles with the sheath yarn to substantially fix the sheath yarn, in which the sheath yarn has a three-dimensionally crimped structure.

The “synthetic fibers” refers to fibers made of a synthetic polymer, and refers to synthetic fibers produced by melt spinning, solution spinning or the like. As the polymer, a melt-moldable thermoplastic polymer is suitable for use because it can be made into fibers by a melt spinning method, and fibers can be produced with high productivity.

Examples of the thermoplastic polymer include melt-moldable polymers such as polyethylene terephthalate and copolymers thereof, polyethylene naphthalate, polybutylene terephthalate, polytrimethylene terephthalate, polypropylene, polyolefins, polycarbonate, polyacrylate, polyamides, polylactic acid, and thermoplastic polyurethane. Among these thermoplastic polymers, polycondensation polymers typified by polyesters or polyamides are suitable because these polymers are crystalline polymers and have high melting point so that they are free from deterioration or fatigue even if they are heated at relatively high temperature in subsequent steps, molding processes and actual use. From the viewpoint of heat resistance, the melting point of the polymer is suitably and preferably 165° C. or higher.

The polymer may contain various additives such as inorganic substances including titanium oxide, silica and barium oxide, coloring agents such as carbon black, dyes and pigments, flame retardants, fluorescent whitening agents, antioxidants, and ultraviolet absorbers.

The bulky yarn used for the batting has a fineness ratio of the sheath yarn to the core yarn (sheath/core) of 0.5-2.0 to exhibit a supple touch. When the fineness ratio is within this range, the fineness of the sheath yarn is so close to that of the core yarn that the bulky yarn can be used without any feeling of foreign body when compressed. In addition, a range in which efficient bulky processing is practicable can include a fineness ratio of the sheath yarn to the core yarn (sheath/core) of 0.7 to 1.5. This range is more preferable in that the desired effect is more remarkable.

For the bulky yarn, it is possible to combine various fibers. However, from the viewpoint of efficient fluid processing and no feeling of foreign body when compressed as described above, the core yarn and the sheath yarn are suitably the same fibers in single yarn fineness and mechanical property. Specifically, it is suitable to prepare two or more fibers produced under the same yarn-making conditions for use in the core yarn and the sheath yarn. In particular, it is preferable that the core yarn and the sheath yarn be single fibers made from one kind of (single) resin.

To make our materials more effective, it is suitable that the three-dimensionally crimped size be millimeter order (10⁻³ m), compared to micrometer order (10⁻⁶ m) in which latent shrunk yarns collected by a general manufacturing method such as a conventional side-by-side composite fiber or hollow fiber are generated. Due to the three-dimensionally crimped size, it is possible to freely control the bulkiness in the circumferential direction and cross-sectional direction of the processed yarn, as well as the resilience. Of course, with use of the resilience, it is also possible to suppress entanglement among yarns. In particular, setting the crimped size to millimeter order (10⁻³ m) makes our materials excellent from the main viewpoint of compatibility of yarn bulkiness and compression recoverability, and additionally balancing with inhibition of yarn entanglement.

As illustrated in FIG. 1, the bulky yarn used for the batting is composed of sheath yarn 1 forming loops and core yarn 2 entangled with the sheath yarn to substantially fix the sheath yarn. The point where the sheath yarn 1 entangles with the core yarn 2 is referred to as an entanglement point. The entanglement points play a role to support the self-supporting loops of the yarn, and are suitably present at a moderate cycle. From this viewpoint, the entanglement points of the core yarn 1 with the sheath yarn 2 in the bulky yarn are present at 1-30/mm. The number of entanglement points within this range is preferable because even when the yarn is three-dimensionally crimped, the loops will be present at a moderate interval. Further from this viewpoint, the entanglement points are preferably present at 3-30/mm, more preferably at 5-15/mm.

To provide one or more entanglement points per mm, a nozzle is not particularly limited, as long as the effect can be achieved. For example, by using a later-described suction nozzle, traveling thread in the nozzle, and further sucking by the suction nozzle and swirling the thread outside the nozzle, an entangled form is provided in which the sheath yarn is wound around the core yarn. When a general interlacing nozzle or taslan nozzle is used, effects of intermingling, opening and interlacing the thread in a nozzle will be imparted, which are not preferable because it is difficult to reach the desired number of entanglement points.

In addition, by swirling the thread outside a nozzle in this way, the excessively supplied side yarn (sheath yarn) will form large loops on the outer layer, resulting in the bulky yarn.

A photoelectric fluff detection device can be utilized to assess the core yarn and the sheath yarn and continuously evaluate the number of loops per unit length in the fiber axis direction of the processed yarn. For example, with use of a photoelectric fluff measuring machine (TORAY FRAY COUNTER), distances of 0.6 mm and 1.0 mm from the surface of the yarn may be evaluated under the conditions of a yarn speed of 10 m/min and a traveling yarn tension of 0.1 cN/dtex.

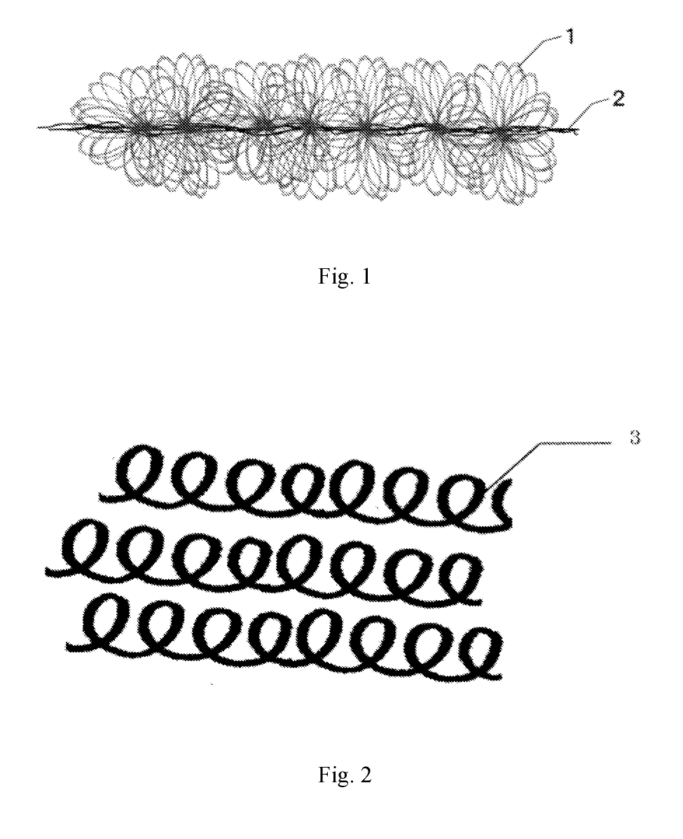

The bulky yarn used for the batting is characterized by having a three-dimensionally crimped structure, that is, a spiral structure, in which the radius of curvature of the yarn is 2.0-30.0 mm. The radius of curvature of the spiral structure corresponds to the radius of a true circle most frequently contacting at two or more points with a three-dimensional crimp 3 formed by fibers having the spiral structure in FIG. 2 in a two-dimensionally observed image by a digital microscope or the like. At each of 10 sites randomly selected from the processed yarn, 10 or more single yarns are collected, and each of the single yarns is observed with a digital microscope or the like at a magnification at which the crimp form of the single yarn can be recognized. In this way, the radii of curvature of a total of 100 single yarns are measured down to the second decimal place in millimeters. The simple average of these measured values is calculated, and a value obtained by rounding off the average to the first decimal place is taken as the radius of curvature of the three-dimensionally crimped structure.

The radius of curvature is more preferably 2.0 mm to 20.0 mm, which means that within such a range, large loops formed of the sheath yarn have crimps like a spring. For this reason, against the compression in the cross-sectional direction of the bulky yarn, the sheath yarn will come into contact at some points, while exhibiting moderate repulsion feeling, resulting in a very comfortable bulkiness. Furthermore, the range is particularly preferably within 3.0 mm to 15.0 mm to satisfactorily exhibit the desired effect. When the radius of curvature is within this range, there is no problem in long-term durability, and the desired effects are positively exerted when used in clothing applications in which compression recovery is repeatedly exerted, particularly sports clothing used under harsh environments.

In a process of producing the bulky yarn, although the fibers are so-called straight fibers at the time of fluid processing described later, the fibers develop the three-dimensional crimp through a heat treatment after the large loops are formed of the sheath yarn. If the fibers are straight at the time of fluid processing, thread is easy to stably travel without blocking a nozzle or the like. Furthermore, when the fibers are straight at the time of fluid processing, even in forming the large loops, the core yarn and the sheath yarn will be so efficiently swirled that the large loops are formed in a very homogeneous manner in the fiber axis direction of the processed yarn. Based on the crystallization temperature of a polymer for use in the processed yarn, by a heat treatment of the processed yarn on the outer layer of which the large loops are formed, the processed yarn develops the three-dimensional crimp, resulting in a bulky structure yarn. The three-dimensional crimp of the yarn develops satisfactory bulkiness both in the circumferential direction and in the cross-sectional direction of the processed yarn. It is suitable to control the three-dimensional crimp to a moderate level depending on the desired characteristics. From the viewpoint of control of crimp development after this heat treatment, the fibers are preferably latent crimped fibers.

The latent crimped fibers are in the straight form before heat treatment, and crimps develop after the heat treatment. For example, after the yarn is discharged through a spinneret, it is preferable to forcibly cool one side of the yarn with excessive cooling air or the like, or excessively heat-treat one side of the yarn with a heating roller or the like during stretching, because a difference in crystal structure is produced in the cross-sectional direction of the fiber. When the speed of the cooling air during spinning is 15 m/min or more, the radius of curvature of the sheath yarn forming the loops of the fluid processed yarn is 30 mm or less. Accordingly, it is preferable that the speed of the cooling air during spinning be 15 m/min or more. On the other hand, when the speed of the cooling air during spinning exceeds 100 m/min, yarn swaying occurs, which causes deterioration in operability such as yarn breakage. Accordingly, it is not preferable that the speed of the cooling air during spinning exceed 100 m/min.

In summary, the fiber-filled material is composed of batting and ticking made of synthetic fibers, characterized in that the batting made of synthetic fibers comprises a bulky yarn in which

(1) the fineness ratio of a sheath yarn to a core yarn (sheath/core) is 0.5-2.0,
(2) entanglement points of the core yarn with the sheath yarn in the fiber axis direction are present at 1-30/mm, and
(3) the radius of curvature of the sheath yarn forming loops is 2.0-30.0 mm.

It is preferable that the fibers having the three-dimensionally crimped structure be hollow cross section fibers. From the viewpoint of the lightweight and heat retaining property, it is suitable for the batting that the density (weight per unit volume) of the yarn be lower. Accordingly, fibers having a hollow cross section are preferably used. From the viewpoint of the lightweight property of the yarn, fibers having a hollow cross section more preferably have a hollow rate of 20% or more.

The hollow ratio is determined by cutting a fiber having a hollow cross section to two-dimensionally photograph the cut surface of the fiber at a magnification at which 10 or more fibers can be observed with an electron microscope (SEM). From the photographed image, 10 fibers are randomly selected and extracted, and the areas of the fibers and the hollow portions are measured with image processing software. Then, the area ratio is determined. All of the above values are determined through measurement for 10 images, and the average value for 10 images is taken as the hollow ratio of the hollow cross section fibers. In addition, to simply evaluate the hollow ratio, the side surface of the fiber is observed with a microscope or the like, and the fiber diameter in terms of the round cross section is measured from the image. From the fiber diameter, it is also possible to calculate the hollow ratio by evaluating the ratio of actually measured fineness (actually measured weight) to converted fineness (converted weight) as a solid fiber.

As to the hollow ratio, from the viewpoint of lightweight and heat retaining property, the bulky yarn suitably has more air layers. Thus, the hollow rate is particularly preferably 30% or more. Within such a range, it is possible to actually feel better lightweight property when holding a bundle of the processed yarn. Furthermore, it is meant to have an air layer with a lower thermal conductivity. Accordingly, the heat retaining property is also excellent.

The bulky yarn used in the batting has excellent bulkiness, and it is preferable that the yarns that constitute the bulky yarn have moderate resilience. In consideration of the desired effect, it is preferable that the constituent synthetic fibers have a single yarn fineness of 3.0 dtex or more. Because such resilience allows the batting to include voids among the fibers, in other words, form many fine air layers, the resilience contributes to lightweight feeling and also heat retaining property.

In this sense, it is preferable that constituent filaments have moderate rigidity, and it is more preferable that the single yarn fineness be 6.0 dtex or more. The fineness means a value calculated from the obtained fiber diameter, number of filaments and density, or a value of the weight per 10000 m calculated from the simple average value of a plurality of measurements of the weight of the fibers per unit length.

The bulky yarn preferably has a breaking strength of 0.5-10.0 cN/dtex, an elongation of 5-700% and a Young's modulus of 8-13 Gpa. The breaking strength is a value obtained by drawing a load-elongation curve of a processed yarn under the conditions shown in JIS L1013 (1999), and dividing the load value at break by the initial fineness. The elongation is a value obtained by dividing the elongated length at break by the initial sample length. The Young's modulus is a stress that produces 100% elastic strain, in other words, 100% elastic recovery stress.

The breaking strength of the bulky yarn is preferably 0.5 cN/dtex or more for the bulky yarn to have step passability in a high-order processing step and to be capable of withstanding practical use. The practicable upper limit of the breaking strength is 10.0 cN/dtex. In addition, it is preferable that the elongation be 5% or more in consideration of step passability in a post-processing step, and the practicable upper limit of the elongation is 700%. Because the Young's modulus represents the suppleness of yarn, and thus represents the suppleness of batting composed of the bulky yarn, that is, compressive elasticity. When the Young's modulus is 8 Gpa or less, the yarn is too soft to reach a practical level bulkiness. When the Young's modulus is 13 GPa or more, the yarn is so hard and the compressive elasticity required of batting is so high that the suppleness is insufficient, which is not preferable. Furthermore, the Young's modulus is preferably 8-12 Gpa.

The breaking strength and elongation can be adjusted by controlling the conditions in a producing step depending on the intended use. When the bulky yarn is used in applications of general clothing such as inner and outer clothing, or bedclothes such as futons and pillows, the breaking strength is preferably 0.5-4.0 cN/dtex. Furthermore, in sports clothing applications in which the usage conditions are relatively harsh, the breaking strength is preferably 1.0-6.0 cN/dtex.

In the batting, with use of the bulky yarn, it is possible to provide air included in many fine voids among the single fiber yarns and maintain a three-dimensionally crimped form. In addition, it is possible to achieve batting having supple texture, lightweight property and excellent compression recovery ratio. All of the bulkiness indicating the lightweight property, the compression height indicating the compression recovery ratio, and the recovery height are indicators representing the volume including air layers under a constant load. That is, as the numerical value of the bulkiness is larger, the lightweight feeling is improved. As the numerical value of the compression height is higher, the supple texture is improved. As the numerical value of the recovery height is higher, batting has excellent recoverability after compression and excellent elasticity.

We found that when made into a filled material, the bulky yarn is excellent in initial bulkiness of the filled material, and even when repeatedly undergoing compression recovery for use, the bulky yarn can satisfactorily restore the original bulk without fatigue. This means that the sheath yarn that is substantially responsible for initial bulkiness and recoverability upon compression has resilience due to the crimped structure. Accordingly, the above-mentioned compression recoverability will be so excellent that good puff feeling can be maintained even after a long time use.

Furthermore, the bulky yarn having three-dimensional crimps can create many fine voids inside the batting. This is because the bulky yarn is characterized in that (2) entanglement points of the core yarn with the sheath yarn in the fiber axis direction are present at 1 to 30/mm, and (3) the radius of curvature of the sheath yarn forming loops is 2-30 mm. Accordingly, the batting composed of the bulky yarn can maintain the initial bulkiness, as well as the radially opened state in the cross-sectional direction of the processed yarn over time (FIG. 1). The spring-like behavior of the radially opened sheath yarn is difficult to achieve with conventional merely straight filaments. In addition, the spring-like behavior of the radially opened sheath yarn is caused by repulsion of the sheath yarn to itself. Furthermore, the sheath yarn having three-dimensional crimps support itself. Accordingly, it is possible to greatly suppress fatigue of the sheath yarn. Also, even when wetted with water such as rain and sweat, the three-dimensionally crimped structure exhibits above-mentioned Young's modulus. Accordingly, exhibiting the spring-like rigid behavior hardly decreases the bulkiness even when wetted, which is one of the desired effects. In other words, even when wetted with water, the bulkiness required of the batting is maintained so that many contained fine voids also maintain heat retaining property. Furthermore, we found that the three-dimensionally crimped structure is good for water drainage because water droplets in the batting are easy to flow. As described later, we found that the bulky yarn is extremely excellent in bulkiness and drying speed when wetted, and thus has very excellent characteristics when used as a filled material in various applications.

Such a bulky yarn can be also obtained by applying a processed yarn processed for the purpose of increasing the added value of fibers, but it is particularly preferable to use a bulky yarn obtained by a method of producing a bulky yarn having a bulky core-sheath structure, including mixing one type or two or more types of fibers described below using a fluid processing nozzle or the like.

Although it is possible to insert the bulky yarns into ticking one by one, it is preferable to provide as a packing form a bundle of several to several tens of yarns or a sheet-like material in which several to several tens of yarns are arranged side by side. When this sheet-like material is formed, it is easy to fill it into ticking and the filling amount is easily adjusted depending on the application so that it becomes a thin material having lightweight and heat retaining properties, and further does not come out from ticking. Accordingly, there is no need to unnecessarily perform sewing. Therefore, there is no restriction on the form of fiber products so that complicated design and the like become possible, which can be a particularly preferable form.

The batting obtained by using the bulky yarn preferably has a bulkiness measured by the measurement method described later of 7000 cm³/30 g or more, a compression ratio of 70% or more, and a recovery ratio of 50% or more. As a result, superior lightweight feeling and more supple texture can be achieved. In consideration of productivity of the bulky yarn and filling efficiency of the batting, the bulkiness is particularly preferably 13120 cm³/30 g or less.

As the form of the batting, a spherical or radial granular cotton form mainly composed of short fibers, fibrous web form, sheet-like cotton form or bulky yarn form mainly composed of long fibers can be adopted. Among these batting forms, a bulky yarn form mainly composed of long fibers is preferable in which, in addition to the basic characteristics described above, effective characteristics for use when wetted (for example, long-term use or actual use is assumed) have been found.

For the batting composed of the bulky yarn, even when the batting contains a lot of moisture, in other words, when wetted or when moisture such as sweat during sports or the like infiltrates the batting, it is preferable that the bulkiness lowering property be maintained as represented formulae (1) and (2).

It is preferable that the bulkiness in a dry state after repeatedly washed five times be 6500 cm³/30 g or more and the bulkiness lowering property when wetted satisfy:

(A−B)/A≤0.3 (1)

(A−C)/A≤0.2 (2)

A: Bulkiness (cm³/30 g) in a dry state after repeatedly washed five times
B: Bulkiness (cm³/30 g) in a wet state (moisture content of 50%)
C: Bulkiness (cm³/30 g) in a wet state (moisture content of 35%) wherein the moisture content (%) is represented by the formula below:

Moisture content (%)=(W1−W0)/W0×100%
W1: weight when wetted (g)
W0: weight when dried (g).

The dry state does not refer to the absolutely dried state but a state when the official “moisture regain” of the fiber is reached. Generally, the official moisture regain of the fiber can be reached by allowing the fiber to stand for 48 hours in an environment with a temperature of 20° C. and a humidity of 65%. The official moisture regain of polyester is 0.3%.

It is suitable to use a finely meshed net or use ticking made of woven or knitted fabric when evaluating the filled material by a washing method. The washing method will be described later. The net is not particularly limited as long as it is made of a tissue that prevents the batting from being exposed outside during washing, especially during dehydration, but from the viewpoint that the batting is hardly exposed, ticking made of woven or knitted fabric is more suitably used.

In the fiber-filled material, we found that, compared to a dry state, the three-dimensional structure of the bulky yarn is maintained even in a wet state so that the rate of decrease in bulkiness is small. Even when wetted during harsh sports such as climbing, the bulkiness is less likely to deteriorate. The bulkiness is directly proportional to the heat retaining property. In other words, high bulkiness means that the amount of dead air (immobile air) in the filled material is large and thus the thermal conductivity of air is low. Accordingly, the heat retaining property is also high.

The dry state refers to a state after the filled material is left in an environment of a temperature of 20 degrees and a humidity of 65% for 48 hours.

It is preferable that the fiber-filled material have a bulkiness of 6500 cm³/30 g or more in the dry state, a compression height representing the compression recovery ratio of 60 mm or more, and a recovery height of 40 mm or more even when repeatedly washed five times. More preferably, the bulkiness in the dry state is 6700 cm³/30 g or more even when repeatedly washed five times. In consideration of productivity of the bulky yarn and filling efficiency of the batting, it is particularly preferable that the bulkiness be 13120 cm³/30 g or less, the compression height be 120 mm or less, and the recovery height be 100 mm or less even when repeatedly washed five times.

It is preferable that the bulkiness lowering property at 50% moisture content be less than 0.3. It is more preferable that it is less than 0.28. The lower limit of the bulkiness lowering property is not particularly set, but in consideration that moisture cannot spread throughout the three-dimensional structure of the sheath yarn responsible for the bulkiness, it is preferable that the bulkiness lowering property be 0.05 or more.

On the other hand, it is preferable that the bulkiness lowering property at 35% moisture content be less than 0.2. The lower limit of the bulkiness lowering property is not particularly set, but in consideration that moisture cannot spread throughout the three-dimensional structure of the sheath yarn responsible for the bulkiness, it is preferable that the bulkiness lowering property be 0.05 or more.

Although it is a well-known fact that the bulkiness of batting is largely related to heat retaining property, we found that even when the batting is wetted, it is possible to reduce the decrease in bulkiness, that is, even when wetted, it is possible to exert heat retaining property.

Because the sheath yarn responsible for the bulkiness has a three-dimensionally crimped structure, and as described above, it is suitable that the three-dimensionally crimped size be millimeter order (10⁻³ m), moisture is easy to enter and exit. Accordingly, even in the wet state, for example, in a state of 50% moisture content or 35% moisture content, fine voids not containing moisture remain, which can greatly contribute to maintenance of heat retaining property.

The evaluation index of heat retaining property is an integral product (unit: W·min/° C.·m²) of the amount of consumed heat. The calculating method is in accordance with JIS L1096 Method A: measuring heat retaining property (constant temperature method, measuring instrument: KES-F7), including determining an amount of consumed heat when a specific moisture content is reached from another specific moisture content to produce an integral product (unit: W·min/° C.·m²) of an area with respect to the horizontal axis (time).

The smaller the amount of consumed heat, the less the amount of taken heat so that the heat retaining property is high. In the fiber-filled material composed of batting and ticking, it is preferable that the heat retaining property be high when wetted. The wet state refers to a state where moisture such as sweat during intense exercise such as sports is contained in the batting. Specifically, it is preferable that the integral product of the amounts of consumed heat from 50% moisture content to 5% moisture content be 25 W·min/° C.·m² or less. Furthermore, it is preferable that the integral product of the amounts of consumed heat from 50% moisture content to 35% moisture content be 15 W·min/° C.·m² or less.

It is preferable that the sheath yarn responsible for the bulkiness have a three-dimensionally crimped structure, and be not partially broken but form continuous loops. The three-dimensionally crimped structure means a spiral structure of a filament single yarn as illustrated in FIG. 2, which has three-dimensional crimps 3.

For evaluation of the three-dimensional crimps, at each of 10 sites randomly selected from a processed yarn, 10 or more single yarns are collected, and each of the single yarns is observed with a digital microscope or the like at a magnification at which the crimp form of the single yarn can be recognized. In these images, if the observed single yarn has a spirally swirling form, the single yarn is determined to have a three-dimensionally crimped structure, and if the observed single yarn has a straight form, the single yarn is determined not to have a three-dimensionally crimped structure.

To be more effective, it is suitable that the three-dimensionally crimped size be millimeter order (10⁻³ m), compared to micrometer order (10⁻⁶ m) in which latent shrunk yarns collected by a general manufacturing method such as a conventional side-by-side conjugate fiber or hollow fiber are generated.

Due to the three-dimensionally crimped size, it is possible to freely control the bulkiness in the circumferential direction and cross-sectional direction of the processed yarn, as well as the resilience. Of course, with use of the resilience, it is also possible to suppress entanglement among yarns. In particular, setting the crimped size to millimeter order improves excellence from the main viewpoint of compatibility of yarn bulkiness and compressibility, and additionally balancing with inhibition of entanglement among yarns.

Furthermore, it is preferable to make a silicone oil agent uniformly adhere to the bulky yarn before being used as batting. A silicone film may be formed on the sheath yarn and the core yarn by moderately crosslinking the silicone for adhesion through a heat treatment or the like.

The silicone oil agent includes dimethylpolysiloxane, hydrogen methylpolysiloxane, aminopolysiloxane and epoxypolysiloxane, and these may be used alone or as a mixture. From the viewpoint of forming a uniform film on the bulky yarn, a dispersant, a viscosity modifier, a crosslinking accelerator, an antioxidant, a flame retardant and an antistatic agent may be contained as long as the desired effect of the adhesion of silicone is not impaired.

A neat or an aqueous emulsion silicone-based oil agent may be used, but from the viewpoint of uniform adhesion of the oil agent, an aqueous emulsion silicone-based oil agent is preferably used. It is suitable that the silicone oil agent be treated such that 0.1-5.0% by mass of the silicone oil agent can be made to adhere to the bulky yarn with use of an oil agent guide, an oiling roller or a spray. After that, it is preferable to dry the oil agent at an arbitrary temperature for an arbitrary time period to cause a crosslinking reaction.

The silicone oil agent can be made to adhere in plural installments, and it is also suitable to laminate a strong silicone film by making one kind of silicone or different kinds of silicone adhere in plural installments. Forming a silicone film on the bulky yarn by the above-mentioned treatment can improve the slidability and touch of the bulky yarn, and further enhance the desired effects.

The ticking used for the fiber-filled material is not particularly limited, but may be woven fabric or knitted fabric. The ticking may be a combination of woven fabric on one side and knitted fabric on another side. It is preferable for the ticking to use dense woven fabric to achieve heat retaining property. The density of the fabric is not particularly limited, but the cover factor, which is a sum of the weft yarn density and the warp yarn density, is more preferably 1500 or more, because the effect of blocking air can be exerted more.

In addition, it is preferable that the drying time period when 25% moisture content is reached from 50% moisture content of the fiber-filled material composed of batting and ticking be 50 minutes or less. We found that the three-dimensionally crimped size of the bulky yarn used for the batting is millimeter order (10⁻³ m), and thus moisture is easy to enter and exit so that the drying speed is also very fast. We found that due to very quick drying property, the fiber-filled material can be quickly recovered from intense wetting by which the heat retaining property decreases. The drying speed is a time period when 25% moisture content of the fiber-filled material is reached from 50% moisture content.

The bulky yarn used for the batting is greatly improved in drying speed, because of a three-dimensionally crimped size of the order of millimeter (10⁻³ m). Specifically, it preferably takes 45 minutes or more to reach 5% water content from 50% moisture content. In other words, the drying speed is preferably 1.0% (moisture content)/min or more.

The fiber-filled material is preferably characterized in that the ticking and the batting are quilt-stitched. A quilt-stitching method is not particularly limited, and the longitudinal direction of the batting may be arranged in parallel in the quilt, or may be arranged vertically with the quilt. It is also preferable that both ends of the batting or any portions in the middle thereof be quilt-stitched. By doing so, slippage of the batting is further improved when wetted or when washing.

Because the highly bulky yarn used for the batting is of a long fiber type, it does not produce fine dust like natural feathers. Thus, it is possible to use many kinds of ticking having a wide range of densities such as woven fabric and knitted fabric. In particular, preferred ticking is fabric having an air permeability of 1.0 cc/cm²·second or more.

It is preferable that the dusting property of the fiber-filled material composed of the batting and the ticking having an air permeability of 1.0 cc/cm²·second or more be extremely small. It is preferable that the dusting property be 100/minute or less by the measurement method described later.

The fiber-filled material is preferably a fiber product at least partly used. The “fiber products” can be used in applications such as general clothing, sports clothing, clothing materials, interior products such as carpets, sofas and curtains, vehicle interior products such as car seats, daily necessaries such as cosmetics, cosmetic masks, wiping cloths and health supplies, and environmental and industrial materials such as filters and products for removing hazardous substances.

In particular, the fiber-filled material is suitable for clothing such as jackets, pants and winter clothes because it is excellent in heat retaining property when wetted. Furthermore, the fiber-filled material is more suitable for sports applications because of its superior quick drying property.

Hereinafter, an example of the producing method will be described in detail.

As the core yarn and the sheath yarn, synthetic fibers obtained by fiberizing a thermoplastic polymer by a melt spinning method may be used.

The spinning temperature during spinning to obtain the synthetic fibers is a temperature at which the used polymer exhibits fluidity. The temperature at which the polymer exhibits fluidity varies depending on the molecular weight. An indication of the temperature is the melting point of the polymer, and the temperature may be set at a temperature equal to or lower than the melting point+60° C. A temperature equal to or lower than the melting point+60° C. is preferable because the polymer will not be thermally decomposed in a spinneret or a spinning pack, and reduction in the molecular weight is suppressed. In addition, the discharge amount of the polymer may be, for example, 0.1 g/min/hole-20.0 g/min/hole per discharge hole, because a discharge amount within this range allows stable discharge of the polymer.

The molten polymer discharged in this manner is cooled and solidified, imparted with an oil agent, and then taken up with a roller whose speed is regulated to be formed into synthetic fibers. The take-up speed should be determined according to the discharge amount and the intended fiber diameter. It is preferable to set the take-up speed in a range of 100-7000 m/min to stably produce the fibers. From the viewpoint of improving the highly oriented mechanical properties, the synthetic fibers may be wound up and then stretched, or the synthetic fibers may be stretched without being wound up once. As for the stretching conditions, for example, in a stretching machine having one or more pairs of rollers, in fibers made of a polymer providing melt-spinnable synthetic fibers, generally, the polymer is easily stretched in the direction of the fiber axis by the circumferential speed ratio of a first roller set at a temperature equal to or higher than the glass transition and equal to or lower than the melting point to a second roller having a temperature corresponding to the crystallization temperature, and is wound up while being thermally set. In a polymer that exhibits no glass transition, a dynamic viscoelasticity measurement (tan δ) of the composite fibers may be carried out, and a temperature equal to or higher than the peak temperature on the high temperature side of tan δ obtained may be selected as a preliminary heating temperature. From the viewpoint of increasing the stretch ratio and improving the mechanical properties, it is also a suitable means to carry out the stretching step in multiple stages.

The cross-sectional shape of the synthetic fibers is not particularly limited, and fibers having a general round cross section, a triangular cross section, a Y-shaped cross section, an octofoil cross section, a flat cross section, or an amorphous shape such as a polymorphic cross section or a hollow cross section can be obtained by changing the shape of the discharge hole of the spinneret. Further, there is no need to form the synthetic fibers from a single polymer, and the fibers may be composite fibers formed from two or more kinds of polymers. However, from the viewpoint of developing the three-dimensional crimps of the sheath yarn, which is important, it is appropriate to use side-by-side composite fibers having a hollow cross section and including two kinds of polymers bonded together.

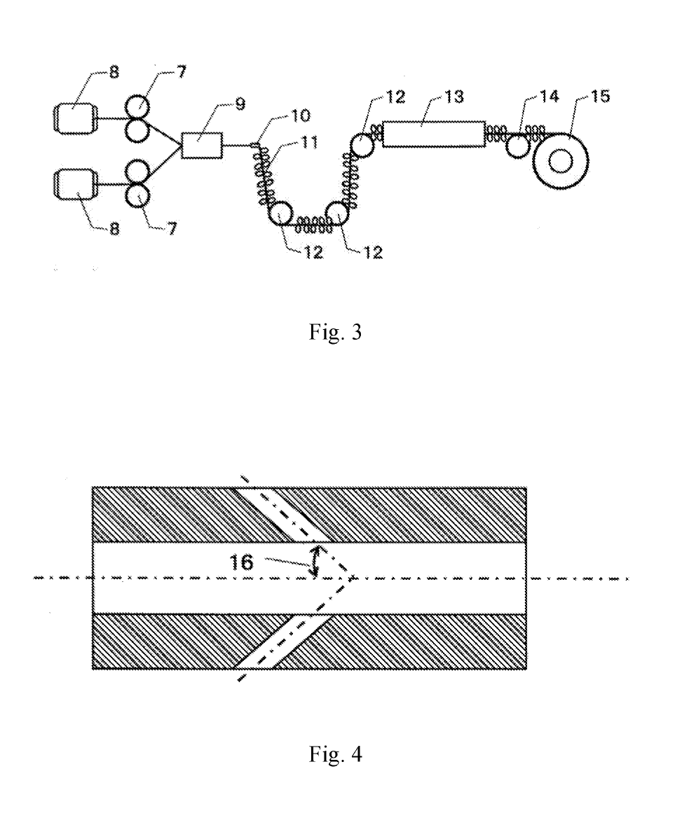

To produce the bulky yarn, the first step is a step of supplying the above-described synthetic fibers (reference sign 8 in FIG. 3) in a specified amount by supply rollers (reference sign 7 in FIG. 3) having a nip roller or the like, and sucking the core yarn and the sheath yarn by a suction nozzle (reference sign 9 in FIG. 3) capable of injecting compressed air. In the suction nozzle (reference sign 9 in FIG. 3), the flow rate of compressed air injected from the nozzle should be such a flow rate that the thread inserted from the supply rollers into the nozzle has the minimum required tension and stably travels between the supply rollers and the nozzle and within the nozzle without swaying or the like. The optimum flow rate of this compressed air changes depending on the hole diameter of the suction nozzle to be used. An indicator of the range in which the tension can be imparted to the thread and the large loops described later can be smoothly formed is an air speed in the nozzle of 100 m/s or more. An indicator of the upper limit of the air speed is 700 m/s or less. When the air speed is within this range, the thread will stably travel inside the nozzle without being swayed or the like by the excessively injected compressed air.

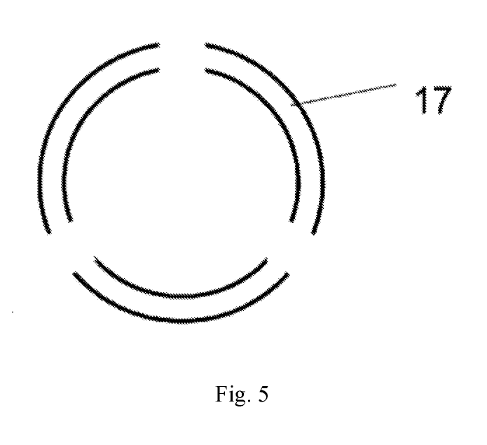

In addition, from the viewpoint of preventing intermingling and opening inside the nozzle, a propellant air jet stream injected at an injection angle (reference sign 16 in FIG. 4) of compressed air less than 60° with respect to the traveling thread is preferable, which is also suitable from the viewpoint of homogeneously forming large loops with the yarn with high productivity. Processing with a vertical air jet stream of a fluid injected at 90° with respect to the traveling thread is of course capable of producing the bulky yarn. However, processing with a propellant air jet stream is preferable from the viewpoint of suppressing opening of the traveling thread and entanglement among single yarns in a narrow space in the nozzle due to the injection of the air jet stream from the vertical direction. Processing with the propellant air jet stream can also suppress formation of arch-shaped small loops in a short cycle, which are easily formed in the vertical air jet stream.

It is suitable not to carry out intermingling or opening in the suction nozzle to form large loops of the sheath yarn required for the bulky yarn. From the viewpoint of making a multifilament composed of several to several tens of yarns travel in the nozzle without being opened, it is more preferable that the injection angle of compressed air be 45° or less with respect to the traveling thread. Furthermore, to form large loops outside the nozzle as described later, it is suitable that the injected air stream immediately behind the nozzle have high stability and high propelling power. From this viewpoint, the injection angle is particularly preferably 20° or less with respect to the traveling thread.

Next, the second step is a step of swirling the thread sucked by the suction nozzle outside the nozzle to form large loops with the yarn.

There are examples where the thread led to the suction nozzle is fed at once or in two installments. To produce the bulky yarn, it is suitable to process the yarn by feeding the threads in two installments. The term “two-feed” means a method of supplying to the nozzle two or more yarns having different supply speeds (amounts) from each other by supply rollers or the like in advance, by which, with use of the swirling force by the air flow described later, the excessively supplied side yarn (sheath yarn) will form large loops on the outer layer, resulting in the bulky yarn. When feeding in two installments is carried out, it is also possible to produce a processed yarn having loops by an interlacing nozzle or a taslan nozzle that imparts the effects of intermingling, opening and interlacing to the traveling thread inside the nozzle.

However, with the yarn processed by such a processing nozzle, the loops are reduced in size in addition to being formed in a short cycle. Therefore, to produce our bulky yarn, it is necessary to precisely control a large number of parameters, but it is very difficult to do so. In addition, when multi-spindle spinning is carried out, there is a possibility that the bulkiness of the processed yarn will be different by the spindle. Thus, it is suitable to employ a technique based on air stream control outside the nozzle as described later also from the viewpoint of stability of the quality. In this regard, based on a concept that large loops can be formed by swirling two yarns supplied at a position distant from the nozzle without performing intermingling or opening treatment in the nozzle, as a result of intensive studies from the viewpoint of controlling the airflow injected from the nozzle, when the ratio of the air stream speed to the yarn speed (air stream speed/yarn speed) is 100 to 3000, a specific phenomenon that the sheath yarn swirls while opening has been found.

The air stream speed refers to a speed of the air stream injected from the downstream of the suction nozzle accompanying the traveling thread, which speed can be controlled by the discharge diameter of the nozzle and the flow rate of compressed air. Further, the yarn speed can be controlled by the circulating speed of a roller that takes up the processed yarn behind the fluid processing nozzle. Because the swirling force of the traveling thread increases or decreases depending on the speed ratio between the air stream and the yarn, in strengthening the entanglement point of the intended bulky yarn, this speed ratio should be approximately 3000. Alternatively, in loosening the entanglement point, this speed ratio should be approximately 100. Varying this speed ratio, for example, by intermittently varying the flow rate of compressed air, or by varying the speed of the take-up roller, can vary the degree of the entanglement point. Meanwhile, when the bulky yarn is used in applications in which repeated deformation of compression recovery is applied as in the batting, it is preferable to set the air stream speed/yarn speed to 200 to 2000. In particular, in producing a processed yarn used in clothing such as jackets to which deformation is frequently applied, it is particularly preferable to set the air stream speed/yarn speed to 400 to 1500 from the viewpoint of imparting moderate binding and flexibility.

The swirling point (reference sign 10 in FIG. 3), which is a base point where the swirling force is developed, is started at which the traveling thread is separated from the accompanying air stream. More specifically, it is sufficient to change the yarn path with a bar guide or the like, and by taking up the traveling thread at a specified speed with the take-up roller (reference sign 12 in FIG. 3) in the traveling direction of the traveling thread, the sheath yarn swirls around the core yarn to form large loops. From the viewpoint of ensuring the space for the swirling and of loosening the yarn by the vibration utilizing the diffusion of the air stream injected from the nozzle, it is suitable that the swirling point of the traveling thread be located away from the nozzle discharge hole. However, the distance between the nozzle and the swirling point which is suitable for producing the bulky yarn varies depending on the speed of the ejected air stream. The swirling point (reference sign 10 in FIG. 3) is preferably present within a range in which the ejected air stream travels for 1.0×10⁻⁵ to 1.0×10⁻³ seconds. To form entanglement points of the core yarn with the yarn at an appropriate cycle in balance with the diffusion of the air stream, the distance between the nozzle and the swirling point is more preferably present within a range in which the ejected air stream travels for 2.0×10⁻⁵ to 5.0×10⁻⁴ seconds.

Adjusting the swirling point also enables control of the cycle of the entanglement points of the bulky yarn. The entanglement points play a role to support the self-supporting loops of the sheath yarn, and are suitably present at a moderate cycle. From this viewpoint, it is preferable to adjust the swirling point so that the core yarn and the sheath yarn in the bulky yarn have 1 to 30/mm entanglement points. The number of entanglement points is preferably within this range because, even after the sheath yarn is three-dimensionally crimped, the loops are present at a moderate interval. Further from this viewpoint, it is more preferable to adjust the swirling point such that the number of entanglement points be 5 to 15/mm.

The processed yarn (reference sign 11 in FIG. 3) having large loops of the sheath yarn is preferably subjected to a heat treatment after being wound up once or following a bulky processing for the purpose of fixing the form and developing the three-dimensional crimps. FIG. 3 illustrates a processing step of carrying out a heat treatment subsequently to a large loop forming step.

This heat treatment process (reference sign 13 in FIG. 3) is performed by heating the processed yarn with a heater or the like, in which an indicator of the processing temperature is the crystallization temperature of the used polymer ±30° C. When the heat treatment is carried out at a temperature within this range, there is no fused or cured portion among the yarns, and no feeling of a foreign body, and the good touch of the bulky yarn is not impaired, because the treatment temperature is far from the melting point of the polymer. The heater used in the heat treatment step may be a general contact heater or non-contact heater. From the viewpoint of bulkiness before the heat treatment and suppression of deterioration of the yarn, a non-contact heater is suitably adopted. The non-contact heater may be an air heating heater such as a slit heater or a tube heater, a steam heater for heating with high temperature steam, or a halogen heater, a carbon heater, or a microwave heater based on radiation heating.

From the viewpoint of heating efficiency, a heater based on radiation heating is preferable. An indication of the heating time period is, for example, a time period to fix the fiber structure of the fibers that constitute the processed yarn, fix the form of the processed yarn, and complete the crimp development of the yarn through the crystallization. Thus, it is suitable to adjust the treatment temperature and time period according to the desired characteristics. After completion of the heat treatment step, the speed of the processed yarn may be restricted with a roller (reference sign 14 in FIG. 3), and the processed yarn may be wound on a winder or the like having a tension control function (reference sign 15 in FIG. 3). The wound shape is not particularly limited, and it is possible to employ the so-called cheese winding or bobbin winding. In consideration of processing into the final product, it is also possible to preliminarily double a plurality of textured yarns to make a tow, or form a sheet of the textured yarns as it is.

It is preferable to make a silicone oil agent uniformly adhere to the bulky yarn before and after the heat treatment step. A silicone film may be formed on the sheath yarn and the core yarn by moderately crosslinking the silicone for adhesion through a heat treatment or the like. The silicone oil agent includes dimethylpolysiloxane, hydrogen methylpolysiloxane, aminopolysiloxane and epoxypolysiloxane, and these may be used alone or as a mixture. From the viewpoint of forming a uniform film on the bulky yarn, a dispersant, a viscosity modifier, a crosslinking accelerator, an antioxidant, a flame retardant and an antistatic agent may be contained as long as adhesion of silicone is not impaired.

A neat or an aqueous emulsion silicone-based oil agent may be used, but from the viewpoint of uniform adhesion of the oil agent, an aqueous emulsion silicone-based oil agent is preferably used. It is suitable that the silicone oil agent be treated such that 0.1-5.0% by mass of the silicone oil agent can be made to adhere to the bulky yarn with use of an oil agent guide, an oiling roller or a spray.

After that, it is preferable to dry the oil agent at an arbitrary temperature for an arbitrary time period to cause a crosslinking reaction. The silicone oil agent can be made to adhere in plural installments, and it is also suitable to laminate a strong silicone film by making one kind of silicone or different kinds of silicone adhere in plural installments. Forming a silicone film on the bulky yarn by the above-mentioned treatment can improve the slidability and touch of the bulky yarn, and further enhance the desired effects.

### EXAMPLE

Hereinafter, a more specific description is made with reference to Examples. It should be noted that this disclosure is not limited to the following Examples.

A method of measuring each physical property will be described.

### (1) Fineness

The weight of 100 m of fibers was measured and multiplied by 100 to calculate the fineness. This operation was repeated 10 times, and the simple average of the 10 values was obtained. The simple average was rounded off to the first decimal place, and the obtained value was taken as the fineness of the fibers. The single yarn fineness was calculated by dividing the fineness by the number of filaments that constitute the fibers. Also for the single yarn fineness, the value was rounded off to the first decimal place, and the obtained value was taken as the single yarn fineness.

### (2) Number of Entanglement

The number of entanglement is counted as the number of single yarns of sheath yarn entering among single yarns of core yarn.

How to count the number of entanglement:
(a) Collect the sample having an appropriate length
(b) Make both ends of the cut sample adhere to black paper with the core yarn taut
(c) Shoot the sample continuously in the yarn length direction under an observing magnification (×100) condition
(d) Measure the length of the core yarn in one image
(e) Count the number of entanglement in one image
(f) Calculate the number of entanglement of the sample=the number of entanglement/the length of the core yarn in one image. Calculate the number of entanglement per 1 mm.

### (3) Evaluation of Crimped Form (Three-Dimensional Crimp, and Radius of Curvature)

At each of 10 sites randomly selected from the bulky yarn, 10 or more single yarns were collected, and each of the single yarns was observed with Microscope VHX-2000 manufactured by KEYENCE CORPORATION at a magnification at which the crimped form could be recognized. In these images, if the observed single yarn had a spirally swirling form, the single yarn was determined to have a three-dimensionally crimped structure (evaluation: present), and if the observed single yarn had a straight form, the single yarn was determined not to have a crimped structure (evaluation: absent). In addition, from the same image, the radius of a true circle most frequently contacting at two or more points with three-dimensional crimp 3 as shown in FIG. 2 was evaluated using image processing software (WINROOF). The radii of curvature of a total of 100 single yarns randomly extracted as described above were measured down to the second decimal place in millimeters, and the simple average of the measured values was obtained. The simple average was rounded off to the first decimal place, and the obtained value was taken as the radius of curvature of the three-dimensionally crimped structure.

### (4) Bulkiness, Compression Ratio and Recovery Ratio

Generally, a method of evaluating the bulkiness is expressed by the degree of swelling per prescribed weight (the volume including air layers). The bulkiness is also called fill power. Pretreatment: left 35 g of the batting in an environment with a temperature of 20 degrees and a humidity of 65% for 48 hours to be in a dry state.

Input: place 30 g of the batting after the pretreatment in a cylinder container having an inner diameter d of 28.8 cm×height 50 cm. In doing so, it is preferable to slowly place the sample in the cylinder to keep the batting swollen and not to clump. Volume V of the batting having a height of h cm in this cylinder container is expressed by the following equation:

Volume V of batting=π·d²·h/4=651×h (cm³).

Measurement: Read the height when applying each of the following loads on the batting and calculate the bulkiness, compression ratio and recovery ratio by the following equations:
Load for bulkiness: height of sample when 0.15 g/cm² is applied: h0 (cm)
Load for compression height: height of sample when 6.00 g/cm² is applied: h1 (cm)
Load for recovery height: height of sample when 0.15 g/cm² is applied: h2 (cm)

bulkiness (cm³/30 g)=651×h0 Equation A:

compression ratio (%)=(h0−h1)/h0×100% Equation B:

recovery ratio (%)=(h2−h1)/(h0−h1)×100%. Equation C:

When the bulkiness is measured, the batting is placed in the cylinder and then stirred five times around the circumference with a stirring rod. After that, a loading disk applied at 0.15 g/cm² is slowly pushed down such that air does not remain in the cylinder, the hand is gotten off immediately after the disk comes into contact with the batting, and count down is done for 1 minute with a timer. After 1 minute, the numerical value is recorded (to 0.1 cm order) by observing the scale (h0). After the measurement, the disc cover is removed and the sample in the cylinder is stirred five times with a stirring rod to recover the swelling. The above procedure is repeated 3 times to calculate an average value of h0 at 3 times, and the volume of 30 g batting, that is, the bulkiness of the batting is calculated according to above equation A.

When the compression ratio and the recovery ratio are measured, the batting is placed in the cylinder and then stirred five times around the circumference with a stirring rod. After that, a loading disk applied at 6.00 g/cm² is slowly pushed down such that air does not remain in the cylinder, the hand is gotten off immediately after the disk comes into contact with the batting, and count down is done for 5 minutes with a timer. After 5 minutes, the numerical value is recorded (to 0.1 cm order) by observing the scale as the compression height (h1). After that, the load disk is switched to another one applied at 0.15 g/cm², and a height after 5 minutes (h2) is measured as the recovery height. After the measurement, the disc cover is removed and the sample in the cylinder is stirred five times with a stirring rod to recover the swelling. The above procedure is repeated three times to calculate the compression height (mm) and the recovery height (mm) as average values h1 and h2 at three times, respectively, and the compression ratio and the recovery ratio are calculated according to above equations B and C.

For the bulkiness, a bulkiness in a dry state after washed five times [A], bulkiness at 50% moisture content [B], bulkiness at 35% moisture content [C], 50% moisture content bulkiness lowering property [(A−B)/A], and 35% moisture content bulkiness lowering property [(A−C)/A] were evaluated.

### (5) Touch

### Preparation of Cushion Sample:

As ticking, plain weave fabric composed of woolie finished yarn of nylon 20D is used (weft yarn density 80/2.54 cm, warp yarn density 113/2.54 cm). As a cushion sample, 5 g of the batting was filled in the ticking of 21 cm×21 cm.

### Evaluation

The touch of the cushion sample when pressed was evaluated on the following four scales. S: The sample is excellent in bulkiness and flexibility, and has an excellent texture without feeling of a foreign body.

A: The sample has a good texture with bulkiness and flexibility.
B: The sample has bulkiness, and has a good texture without feeling of a foreign body.
C: The sample has no bulkiness, and has a poor texture with feeling of a foreign body.
(6) Repeated washing

The washing method is a method in accordance with JIS L0217 105. The cushion sample is the same one as in (5) above.

Detergent: neutral detergent (usage: 20 g)
Water temperature: 30° C.
Ratio in washing bath: fabric:water=1:60
Washing time period (min): 25 (5 times)
Ratio in rinsing bath: fabric:water=1:65
Rinsing time period (min): 20 (5 times)
Dehydrating time period (min): 10 (5 times).

### (7) Method of Measuring Amount of Consumed Heat (Heat Retaining Property)

Measurement is done in accordance with JIS L1096 Method A: measuring heat retaining property (constant temperature method).

A. Measuring instrument: KES-F 7, Precise and Fast Thermal Property-Measuring Instrument Thermolabo JIB)
B. Temperature of heating plate for heat retaining ratio: 36° C.
C. Preparation of sample: prepare the same cushion sample as in (5) above.
D. Dry state: a state where the sample is left in an environment with a temperature of 20 degrees and a humidity of 65% for 48 hours.
E. Wet condition: after dipping the sample in pure water for 5 minutes, dehydrate the sample with a dehydrator so that the moisture content of the sample reaches 50%, and then start measurement. The measurement is terminated when the moisture content reaches 5%. The amount of consumed heat at 50% moisture content, amount of consumed heat at 35% moisture content, amount of consumed heat at 5% moisture content, integral product of amounts of consumed heat from at 50% moisture content to at 35% moisture content, and integral product of amounts of consumed heat from at 50% moisture content to at 5% moisture content were evaluated. The moisture content is as the following equation.

Moisture content (%)=(W1−W0)/W0×100%

W1: weight when wetted (g)

W0: weight upon dried (g)

The dry state refers to a state after the sample is left in an environment of a temperature of 20 degrees and a humidity of 65% for 48 hours.

### (8) Drying Speed

The same cushion sample as in (5) above is used. After dipping the sample in pure water for 5 minutes, the sample is dehydrated with a dehydrator so that the moisture content reaches 50%, and then measurement is started. Data are collected every 5 minutes and the measurement is terminated when the moisture content reaches 25%.

### (9) Air Permeability

The same cushion sample as in (5) above is used. The air permeability of the ticking was measured in accordance with JIS L1096 (method A).

### (10) Dusting Property

Measurement is done in accordance with JIS B9923 tumbling method. The same cushion sample as in (5) above is used. Particles (particles/minute) having a particle size of 0.3 μm or more are collected and the number of the particles is counted.

### Example 1

Polyethylene terephthalate (PET: IV=0.65 dl/g) was melted at 290° C., weighed, charged into a spinning pack, and discharged through a discharge hole for a hollow cross section having 3 slits 17 (slit width: 0.1 mm) in concentric sectors as shown in FIG. 5 to have a hollow ratio of 30%. Cooling air at 20° C. was blown from one side to the discharged thread at a flowing of 40 m/min, the thread was cooled and solidified, and a nonionic spinning oil agent was imparted to the thread. Then, an unstretched yarn was wound at a spinning speed of 1500 m/min. Then, the wound unstretched yarn was stretched 3.0 times between rollers heated at 90° C. and 140° C. at a stretching speed of 800 m/min to give a stretched yarn having a fineness of 84 dtex and a number of filaments of 12.

In the steps illustrated in FIG. 3, the obtained stretched yarns (synthetic fibers) were suctioned with a suction nozzle such that two of the supply rollers were each supplied with one of the yarns, in which one of the supply rollers was set at a speed of 30 m/min as a core yarn supply speed of the supply speed of the fluid processing condition, while the other of the supply rollers was set at a speed of 600 m/min as a sheath yarn supply speed of the supply speed of the fluid processing condition. As an entanglement condition of the fluid processing condition, the nozzle supply pressure was 0.25 Mpa and the flow rate was 74 L/min for the suction nozzle. Subsequently, the yarns were taken up with a take-up roller at 30 m/min. Then, the processed yarn was led to a tube heater through rollers and heat-treated with heating air at 150° C. for 10 seconds to set the form of the bulky yarn and develop three-dimensional crimps of the yarn. The bulky yarn was wound on a drum at 30 m/min with a tension control type winding machine (winder) installed behind the tube heater.

Subsequently, a silicone oil agent containing polysiloxane at a concentration of 8% by weight was uniformly applied to the bulky yarn so that the final polysiloxane deposition amount would be 1% by weight with respect to the bulky yarn by a patting method. The bulky yarn was heat-treated at a temperature of 170° C. for 5 minutes to collect a processed yarn.

The bulky yarn collected in Example 1 has a millimeter order of three-dimensionally crimped structure, with the entanglement points of the core yarn with the sheath yarn being 13/mm and the radius of curvature of the sheath yarn being 6.5 mm.

Subsequently, 30 g of the bulky yarn was collected to measure characteristics of batting. As a result, the bulkiness, compression ratio and recovery ratio were 8500 cm³/30 g, 94% and 83%, respectively. In touch evaluation, the bulky yarn was excellent in bulkiness and flexibility, and had an excellent texture (S) without feeling of a foreign body. Good results were obtained for bulkiness lowering property when wetted, integral product of amounts of consumed heat, drying speed and dusting property. The results are shown in Table 1.

### Example 2

All procedures were carried out in accordance with Example 1, except that in the entanglement condition of the fluid processing condition, the nozzle supply pressure and flow rate for the suction nozzle were changed, the entanglement points of the core yarn with the sheath yarn were 10/mm, and the radius of curvature of crimp of the bulky yarn was set to 7.5 mm. In Example 2, although the bulkiness, compression height and recovery height were somewhat inferior, in touch evaluation, a good texture (A) having bulkiness and flexibility was obtained. There was no problem with bulkiness lowering property when wetted, integral product of amounts of consumed heat, drying speed and dusting property. The results are shown in Table 1.

### Example 3

All procedures were carried out in accordance with Example 1, except that in the entanglement condition for the fluid processing condition, the nozzle supply pressure and flow rate for the suction nozzle were changed, the entanglement points of the core yarn with the sheath yarn were 20/mm, and the radius of curvature of crimp of the bulky yarn was set to 20 mm. In Example 3, although the bulkiness, compression height and recovery height were somewhat inferior, in touch evaluation, a good texture (A) having bulkiness and flexibility was obtained. There was no problem with bulkiness lowering property when wetted, integral product of amounts of consumed heat, drying speed and dusting property. The results are shown in Table 1.

### Comparative Example 1

The procedure was carried out in accordance with Example 1, except that 56 T-12 was used as the core yarn and 160 T-24 was used as the sheath yarn. In Comparative Example 1, the bulkiness, compression height and recovery height were inferior, in touch evaluation, there was no bulkiness, and a bad texture (C) with a feeling of a foreign body was obtained. There were problems with bulkiness lowering property when wetted, integral product of amounts of consumed heat, drying speed and dusting property in practicality. The results are shown in Table 1.

### Comparative Example 2

All procedures were carried out in accordance with Example 1, except that in the entanglement condition of the fluid processing condition, the nozzle supply pressure and flow rate for the suction nozzle were changed, the radius of curvature of crimp of the bulky yarn was set to 1.0 mm, the interlace points were set to 20/mm, and there was no three-dimensional crimp. In Comparative Example 2, the bulkiness, compression height and recovery height were inferior, in touch evaluation, there was no bulkiness, and a bad texture (C) with a feeling of a foreign body was obtained. The bulkiness lowering property when wetted and integral product of amounts of consumed heat barely reached the practical level, but there were problems with drying speed and dusting property in practicality. The results are shown in Table 1.

### Reference Example

From a commercially available down jacket, 30 g of natural feathers were collected and the characteristics of the batting were evaluated in the same manner as in Example 1. In touch evaluation, excellent bulkiness and flexibility, and excellent texture (S) without feeling of a foreign body were obtained. However, decrease in bulkiness when wetted was large, and results of amounts of consumed heat, drying speed and dusting property did not reach those of Examples 1 to 3. The results are shown in Table 1.

### Example 4

For both core yarn and sheath yarn, 160T-24 was used. The procedure was carried out in accordance with Example 1, except that the supply pressure for the fluid processing nozzle was set to 0.3 MPa, the air flow rate for the nozzle was set to 84 L/min, the entanglement points of the core yarn with the sheath yarn were 13/mm, and the radius of curvature of crimp of the bulky yarn was set to 7.0 mm. In touch evaluation, although the bulkiness and flexibility were excellent, there was a slight feeling of a foreign body so the texture evaluation was A. Good results were obtained for bulkiness lowering property when wetted, integral product of amounts of consumed heat, drying speed and dusting property. The results are shown in Table 2.

### Example 5

160T-24 was used as the core yarn and 84T-12 was used as the sheath yarn. The procedure was carried out in accordance with Example 1, except that the supply pressure for the fluid processing nozzle was set to 0.3 MPa, the air flow rate for the nozzle was set to 84 L/min, the entanglement points of the core yarn with the sheath yarn were 15/mm, and the radius of curvature of crimp of the bulky yarn was 7.0 mm. In touch evaluation, because there was a slight feeling of a foreign body, the texture evaluation was A. Good results were obtained for bulkiness lowering property when wetted, integral product of amounts of consumed heat, drying speed and dusting property. The results are shown in Table 2.

### Example 6

84T-12 was used as the core yarn and 160T-24 was used as the sheath yarn. The procedure was carried out in accordance with Example 1, except that the supply pressure for the fluid processing nozzle was set to 0.3 MPa, the air flow rate for the nozzle was set to 84 L/min, the entanglement points of the core yarn with the sheath yarn were 20/mm, and the radius of curvature of crimp of the bulky yarn was 7.0 mm. In touch evaluation, because there was a slight feeling of a foreign body, the texture evaluation was A. Good results were obtained for bulkiness lowering property when wetted, integral product of amounts of consumed heat, drying speed and dusting property. The results are shown in Table 2.

TABLE 1

| | | | | Example | Example | Example |
|---|---|---|---|---|---|---|
| Items | | | | 1 | 2 | 3 |
| Core yarn | | Polymer species | — | PET | PET | PET |
| | | Original yarn | dtex-F | 84T-12 | 84T-12 | 84T-12 |
| | | composition | number | | | |
| Sheath yarn | | Polymer species | — | PET | PET | PET |
| | | Original yarn | dtex-F | 84T-12 | 84T-12 | 84T-12 |
| | | composition | number | | | |
| Fineness ratio of sheath | | Sheath/core | — | 1 | 1 | 1 |
| yarn to core yarn | | | | | | |
| Fluid | Supply | Core yarn supply | m/min | 30 | 30 | 30 |
| processing | speed | speed | | | | |
| condition | | Sheath yarn supply | m/min | 600 | 600 | 600 |
| | | speed | | | | |
| | Entanglement | Nozzle supply | Mpa | 0.25 | 0.15 | 0.35 |
| | condition | pressure | | | | |
| | | Flow rate | L/min | 74 | 55 | 94 |
| Bulky | Loop | Three dimensional | — | Present | Present | Present |
| yarn | form | crimp | | | | |
| | | Entanglement point | Point(s)/ | 13 | 10 | 20 |
| | | | mm | | | |
| | | Radius of curvature | mm | 6.5 | 7.5 | 28 |
| Silicone oil application | | Deposition amount | wt % | 1 | 1 | 1 |
| Characteristics of | | Bulkiness | cm³/30 g | 8500 | 8200 | 8800 |
| batting | | Compression ratio | % | 94 | 90 | 87 |
| | | Recovery ratio | % | 83 | 80 | 75 |
| | | Touch | — | S | S | A |
| Characteristics | Bulkiness in dry state after washed | | cm³/30 g | 8400 | 8100 | 8700 |
| of fiber-filled | five times [A] | | | | | |
| Material | Bulkiness at 50% moisture content [B] | | cm³/30 g | 7500 | 6600 | 6700 |
| (Batting and ticking) | Bulkiness at 35% moisture content [C] | | cm³/30 g | 8000 | 7900 | 7300 |
| | 50% moisture content bulkiness | | — | 0.11 | 0.19 | 0.23 |
| | lowering property [(A − B)/A] | | | | | |
| | 35% moisture content bulkiness | | — | 0.05 | 0.02 | 0.16 |
| | lowering property [(A − C)/A] | | | | | |
| | Amount of consumed heat at 5% | | W/m² · ° C. | 1.00 | 1.20 | 1.20 |
| | moisture content | | | | | |
| | Amount of consumed heat at 50% | | W/m² · ° C. | 2.78 | 2.90 | 2.80 |
| | moisture content | | | | | |
| | Amount of consumed heat at 35% | | W/m² · ° C. | 1.41 | 1.50 | 1.60 |
| | moisture content | | | | | |
| | Integral product of amounts of consumed | | W · min/ | 9.50 | 11.00 | 12.00 |
| | heat at 50% → 35% moisture content | | m² · ° C. | | | |
| | Integral product of amounts of consumed | | W · min/ | 22.00 | 23.00 | 24.00 |
| | heat at 50% → 5% moisture content | | m² · ° C. | | | |
| | Drying speed (moisture content 50% → 25%) | | Minute | 35.00 | 38.00 | 40.00 |
| | Dusting property | 0.3 μm or more | particle(s)/min | 44.00 | 44.00 | 44.00 |
| | | | | Compar- | Compar- | Refer- |
| | | | | ative | ative | ence |
| Items | | | | Example 1 | Example 2 | Example |
| Core yarn | | Polymer species | — | PET | PET | Natural |
| | | Original yarn | dtex-F | 56T-12 | 84T-12 | feather |
| | | composition | number | | | |
| Sheath yarn | | Polymer species | — | PET | PET | |
| | | Original yarn | dtex-F | 160T-24 | 84T-12 | |
| | | composition | number | | | |
| Fineness ratio of sheath | | Sheath/core | — | 2.9 | 1 | |
| yarn to core yarn | | | | | | |
| Fluid | Supply | Core yarn | m/min | 30 | 30 | |
| processing | speed | supply speed | | | | |
| condition | | Sheath yarn | m/min | 600 | 600 | |
| | | supply speed | | | | |
| | Entanglement | Nozzle supply | Mpa | 0.25 | 0.25 | |
| | condition | Pressure | | | | |
| | | Flow rate | L/min | 74 | 74 | |
| Bulky | Loop | Three dimensional | — | Present | Absent | |
| yarn | form | Crimp | | | | |
| | | Entanglement point | Point(s)/mm | 5 | 13 | |
| | | Radius of curvature | Mm | 4.1 | 32.0 | |
| Silicone oil application | | Deposition amount | wt % | 1 | 1 | |
| Characteristics of | | Bulkiness | cm³/30 g | 6560 | 6000 | 10332 |
| batting | | Compression ratio | % | 55 | 50 | 90 |
| | | Recovery ratio | % | 38 | 35 | 65 |
| | | Touch | — | C | C | S |
| Characteristics | Bulkiness in dry state after washed | | cm³/30 g | 6400 | 5500 | 9000 |
| of fiber-filled | five times [A] | | | | | |
| material | Bulkiness at 50% moisture content [B] | | cm³/30 g | 4264 | 3300 | 2903 |
| (Batting and ticking) | Bulkiness at 35% moisture content [C] | | cm³/30 g | 4800 | 3700 | 3500 |
| | 50% moisture content bulkiness | | — | 0.33 | 0.40 | 0.68 |
| | lowering property [(A − B)/A] | | | | | |
| | 35% moisture content bulkiness | | — | 0.25 | 0.33 | 0.61 |
| | lowering property [(A − C)/A] | | | | | |
| | Amount of consumed heat at 5% | | W/m² · ° C. | 1.20 | 1.20 | 1.00 |
| | moisture content | | | | | |
| | Amount of consumed heat at 50% | | W/m² · ° C. | 3.00 | 3.20 | 2.52 |
| | moisture content | | | | | |
| | Amount of consumed heat at 35% | | W/m² · ° C. | 1.80 | 2.20 | 1.64 |
| | moisture content | | | | | |
| | Integral product of amounts of consumed | | W · min/ | 14.00 | 18.00 | 16.00 |
| | heat at 50% → 35% moisture content | | m² · ° C. | | | |
| | Integral product of amounts of consumed | | W · min/ | 28.00 | 30.00 | 30.00 |
| | heat at 50% → 5% moisture content | | m² · ° C. | | | |
| | Drying speed (moisture content 50% → 25%) | | Minute | 60.00 | 60.00 | 100.00 |
| | Dusting property | 0.3 μm or more | particle(s)/min | 44.00 | 44.00 | 27549 |

TABLE 2

| | | | | Example | Example | Example |
|---|---|---|---|---|---|---|
| Items | | | | 4 | 5 | 6 |
| Core yarn | | Polymer species | — | PET | PET | PET |
| | | Original yarn | dtex-F | 160T-24 | 160T-24 | 84T-12 |
| | | composition | number | | | |
| Sheath yarn | | Polymer species | — | PET | PET | PET |
| | | Original yarn | dtex-F | 160T-24 | 84T-12 | 160T-24 |
| | | composition | number | | | |
| Fineness ratio of sheath | | Sheath/core | — | 1 | 0.5 | 2 |
| yarn to core yarn | | | | | | |
| Fluid | Supply | Core yarn supply | m/min | 30 | 30 | 30 |
| processing | speed | Speed | | | | |
| condition | | Sheath yarn | m/min | 600 | 600 | 600 |
| | | supply speed | | | | |
| | Entanglement | Nozzle supply | Mpa | 0.3 | 0.3 | 0.3 |
| | condition | pressure | | | | |
| | | Flow rate | L/min | 84 | 84 | 84 |
| Bulky | Loop | Three dimensional | — | Present | Present | Present |
| yarn | form | Crimp | | | | |
| | | Entanglement point | Point(s)/mm | 13 | 15 | 20 |
| | | Radius of curvature | mm | 7 | 7 | 7 |
| Silicone oil application | | Deposition amount | wt % | 1 | 1 | 1 |
| Characteristics of | | Bulkiness | cm³/30 g | 7500 | 8200 | 8800 |
| batting | | Compression ratio | % | 91 | 90 | 87 |
| | | Recovery ratio | % | 86 | 80 | 75 |
| | | Touch | — | A | A | A |
| Characteristics | Bulkiness in dry state after washed | | cm³/30 g | 7400 | 8100 | 8600 |
| of fiber-filled | five times [A] | | | | | |
| material | Bulkiness at 50% moisture content [B] | | cm³/30 g | 7000 | 7200 | 6700 |
| (Batting and ticking) | Bulkiness at 35% moisture content [C] | | cm³/30 g | 7200 | 7500 | 7300 |
| | 50% moisture content bulkiness | | — | 0.05 | 0.11 | 0.22 |
| | lowering property [(A − B)/A] | | | | | |
| | 35% moisture content bulkiness | | — | 0.03 | 0.07 | 0.15 |
| | lowering property [(A − C)/A] | | | | | |
| | Amount of consumed heat at 5% | | W/m² · ° C. | 1.00 | 1.20 | 1.20 |
| | moisture content | | | | | |
| | Amount of consumed heat at 50% | | W/m² · ° C. | 2.78 | 2.90 | 2.80 |
| | moisture content | | | | | |
| | Amount of consumed heat at 35% | | W/m² · ° C. | 1.41 | 1.50 | 1.60 |
| | moisture content | | | | | |
| | Integral product of amounts of consumed | | W · min/ | 9.50 | 11.00 | 12.00 |
| | heat at 50% → 35% moisture content | | m² · ° C. | | | |
| | Integral product of amounts of consumed | | W · min/ | 22.00 | 23.00 | 24.00 |
| | heat at 50% → 5% moisture content | | m² · ° C. | | | |
| | Drying speed (moisture content 50% → 25%) | | Minute | 35.00 | 38.00 | 38.00 |
| | Dusting property | 0.3 μm or more | particle(s)/min | 44.00 | 44.00 | 44.00 |

1-8. (canceled)

9. A fiber-filled material composed of batting and ticking made of synthetic fibers, wherein the batting made of synthetic fibers comprises a bulky yarn in which (1) a fineness ratio of a sheath yarn to a core yarn (sheath/core) is 0.5-2.0, (2) entanglement points of the core yarn with the sheath yarn in a fiber axis direction are present at 1-30/mm, and (3) a radius of curvature of the sheath yarn forming loops is 2.0-30.0 mm.

10. The fiber-filled material according to claim 9, wherein the batting made of synthetic fibers has a bulkiness in a dry state of 7000 cm³/30 g or more, a compression ratio of 70% or more, and a recovery ratio of 50% or more.

11. The fiber-filled material according to claim 9, wherein the batting made of synthetic fibers has a bulkiness in a dry state after repeatedly washed five times of 6500 cm³/30 g or more, and has a bulkiness lowering property when wetted satisfying equations (1) and (2):
(A−B)/A≤0.3 (1)
(A−C)/A≤0.2 (2)
A: Bulkiness (cm³/30 g) in a dry state after repeatedly washed five times
B: Bulkiness (cm³/30 g) in a wet state (moisture content of 50%)
C: Bulkiness (cm³/30 g) in a wet state (moisture content of 35%).

12. The fiber-filled material according to claim 9, wherein an integral product of amounts of consumed heat from 50% moisture content to 5% moisture content is 25 W·min/° C.·m² or less.

13. The fiber-filled material according to claim 9, wherein a drying time period when 25% moisture content is reached from 50% moisture content is 50 minutes or less.

14. The fiber-filled material according to claim 9, wherein the ticking and the batting are quilt-stitched.

15. The fiber-filled material according to claim 9, wherein the ticking is made of woven or knitted fabric having an air permeability of 1.0 cc/cm²·second or more, and a dusting property is 100/min or less.

16. A fiber product comprising the fiber-filled material according to claim 9 in at least a portion of the fiber product.
